(19) United States
(12) Patent Application Publication
(10) Pub. No.: US 2018/0056465 A1
(43) Pub. Date: Mar. 1, 2018

(54) FLUID EJECTION DEVICE

(71) Applicant: FANUC CORPORATION, Yamanashi (JP)

(72) Inventor: Hikaru Koshiishi, Minamitsuru-gun (JP)

(73) Assignee: FANUC CORPORATION, Yamanashi (JP)

(21) Appl. No.: 15/684,070

(22) Filed: Aug. 23, 2017

(30) Foreign Application Priority Data
Aug. 30, 2016 (JP) 2016-168218

(51) Int. Cl. B23Q 11/10; B05B 9/08; B05B 12/14

(52) U.S. Cl. CPC B23Q 11/1076; B25J 11/0055; B05B 12/1454; B05B 9/0861

(57) ABSTRACT

A fluid ejection device is equipped with a robot hand, which is attached to a distal end of an arm of an articulated robot, and having ejection holes therein for ejecting a cutting fluid toward a tool holder or a tool, and a controller adapted to control joints of the articulated robot, in such a manner that the robot hand moves along an axial direction (Z-direction) of a spindle in synchronism with a feeding operation by which the spindle is moved along the axial direction (Z-direction) of the spindle.

### CROSS-REFERENCE TO RELATED APPLICATION

This application is based upon and claims the benefit of priority from Japanese Patent Application No. 2016-168218 filed on Aug. 30, 2016, the contents of which are incorporated herein by reference.

### BACKGROUND OF THE INVENTION

### Field of the Invention

The present invention relates to a fluid ejection device adapted to eject a cutting fluid in proximity to a tool that is attached to the spindle of a machine tool during machining of an object machined by a machine tool.

### Description of the Related Art

In carrying out cutting machining and grinding machining using a machine tool, a cutting fluid (coolant liquid), which is a type of machining fluid, generally is used. Such a cutting fluid plays an important role in providing lubrication to the cutting tool, cooling of the object to be machined, and in removal of chips that are generated by performing cutting machining. A tank in which the cutting fluid is stored, and a nozzle (coolant nozzle) for ejecting the cutting fluid are connected together by piping. The cutting fluid that is stored in the tank is made to flow through the piping by a driving means such as a discharge pump or the like, and is ejected from the nozzle.

It is necessary to adjust the position of the nozzle in order to eject the cutting fluid toward the cutting tool. In many current commercially available nozzles, such positional adjustment is carried out manually, and each time that a length of the cutting tool or a position of the cutting tool is changed, it is necessary to adjust the position of the nozzle, and time is required for making such positional adjustments.

In order to solve this type of problem, Japanese Patent No. 4080145 discloses a technique for automatically adjusting the position of a nozzle. To provide a brief description thereof, in conjunction with a machining program that is executed at the time of machining, an angle of the nozzle is automatically changed to thereby change a target ejection position of the cutting fluid.

### SUMMARY OF THE INVENTION

However, with the technique of the aforementioned Japanese Patent No. 4080145, since only the angle of the nozzle is changed, depending on the angle of the nozzle, the distance between the nozzle and a target ejection location (the location on the cutting tool to which the cutting fluid should be supplied) becomes longer. The longer the distance becomes between the nozzle and the target ejection location of the cutting fluid, the harder it is to determine the region where the cutting fluid is supplied. For this reason, the cutting fluid cannot be properly ejected at the target ejection location, and thus the lubricating effect, the cooling effect, and the chip removal effect of the cutting fluid are dramatically decreased.

Thus, an object of the present invention is to provide a fluid ejection device, which is capable of appropriately ejecting a cutting fluid with respect to a target ejection location for the cutting fluid.

The present invention is characterized by a fluid ejection device configured to eject a cutting fluid toward a tool holder or a tool from a periphery of a spindle of a machine tool to which the tool is attached through the tool holder, comprising a robot hand which is attached to a distal end of an arm of an articulated robot, and including an ejection hole therein in order to eject the cutting fluid toward the tool holder or the tool, and a controller configured to control joints of the articulated robot, in a manner that the robot hand moves along an axial direction of the spindle in synchronism with a feeding operation by which the spindle is moved along the axial direction of the spindle.

In accordance with such a configuration, since the robot hand is moved along the movement direction (axial direction) of the spindle in synchronism with the feeding operation of the spindle, the relative positional relationship can be maintained between the robot hand, and the tool and the tool holder that are attached to the spindle. Accordingly, even in the case that the spindle is moved, the cutting fluid can be supplied to the tool or the tool holder, and it is possible to prevent a decrease in the lubrication effect, the cooling effect, and the chip removal effect of the cutting fluid. Since the cutting fluid is ejected using the robot hand that is attached to the arm of the articulated robot, even if the length of the tool is changed by replacement of the tool, such a change can be coped with easily.

In the fluid ejection device of the present invention, the controller may control the joints of the articulated robot, in a manner that the robot hand moves along the axial direction of the spindle while maintaining a state in which the cutting fluid ejected from the ejection hole is supplied to a predetermined specified location of the tool holder or the tool. In accordance with this feature, even in the case that the robot hand is moved along the movement direction of the spindle in synchronism with the feeding operation of the spindle, the cutting fluid can be supplied appropriately to the specified location, and a decrease in the lubrication effect, the cooling effect, and the chip removal effect of the cutting fluid can be prevented.

In the fluid ejection device of the present invention, the robot hand may be formed so as to surround the tool that is attached to the spindle, and a plurality of the ejection holes may be formed in the robot hand. In accordance with this feature, the cutting fluid can be ejected from different directions toward the tool or the tool holder, and it is possible to prevent a decrease in the lubrication effect, the cooling effect, and the chip removal effect of the cutting fluid.

In the fluid ejection device of the present invention, the plurality of ejection holes may be formed in the robot hand in a manner that the cutting fluid is ejected toward a predetermined spatial region, and the controller may control the joints of the articulated robot in a manner that the robot hand moves along the axial direction of the spindle while maintaining a state in which the predetermined spatial region overlaps with the predetermined specified location of the tool holder or the tool. In accordance with this feature, even in the case that the robot hand is moved along the movement direction of the spindle in synchronism with the feeding operation of the spindle, it is possible to supply the cutting fluid to the specified location, which is the target ejection location, from the plurality of ejection holes. Consequently, it is possible to prevent a decrease in the lubrication effect, the cooling effect, and the chip removal effect of the cutting fluid.

In the fluid ejection device of the present invention, the predetermined spatial region may be a region that is smaller than the specified location on a plane perpendicular to the axial direction of the spindle. Owing to this feature, it is possible to reliably eject the cutting fluid toward the specified location, which is the target ejection location.

In the fluid ejection device of the present invention, the robot hand may be formed in a ring-like shape, and the predetermined spatial region may be set on an inner side of the robot hand. In accordance with this feature, since the cutting fluid is supplied from the periphery of the specified location, it is possible to prevent a decrease in the lubrication effect, the cooling effect, and the chip removal effect of the cutting fluid.

According to the present invention, since the robot hand is moved along the movement direction (axial direction) of the spindle in synchronism with the feeding operation of the spindle, the relative positional relationship can be maintained between the robot hand, and the tool and the tool holder that are attached to the spindle. Accordingly, even in the case that the spindle is moved, the cutting fluid can be supplied to the tool or the tool holder, and it is possible to prevent a decrease in the lubrication effect, the cooling effect, and the chip removal effect of the cutting fluid. Since the cutting fluid is ejected using the robot hand that is attached to the arm of the articulated robot, even if the length of the tool is changed by replacement of the tool, such a change can be coped with easily.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a configuration diagram of a machining system;

FIG. 2 is a view for explaining a drive system of a spindle and a table of a machine tool shown in FIG. 1;

FIG. 3 is an enlarged perspective view of the periphery of the spindle, to which a robot hand and a tool shown in FIG. 1 are attached;

FIG. 4 is a flowchart indicating operations of a controller shown in FIG. 1;

FIG. 5A is a diagram showing an example of a state when the robot hand is positioned in step S3 of FIG. 4; and

FIG. 5B is a view showing a state when the robot hand is moved along the Z-direction in synchronism with a feeding operation of the spindle in step S6 of FIG. 4.

### DESCRIPTION OF THE PREFERRED EMBODIMENTS

A preferred embodiment of a fluid ejection device according to the present invention will be presented and described in detail below with reference to the accompanying drawings.

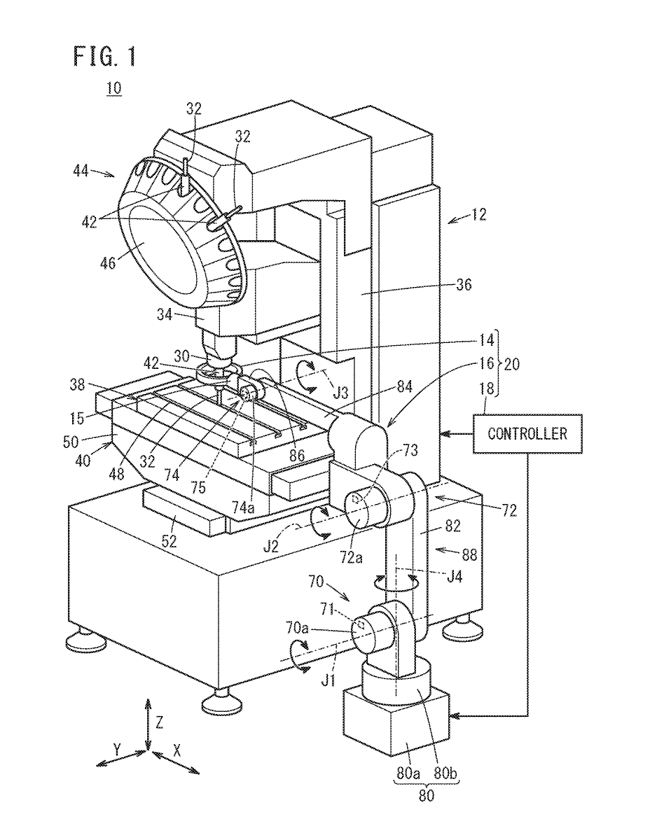

FIG. 1 is a configuration diagram of a machining system 10. The machining system 10 includes a machine tool 12, an articulated robot 16 to which a robot hand 14 is attached, and a controller 18 adapted to control both the machine tool 12 and the articulated robot 16. The robot hand 14, the articulated robot 16, and the controller 18 constitute a fluid ejection device 20.

The machine tool 12 performs machining on an object to be machined (work, workpiece) W with a tool (cutting tool) 32 attached to a spindle 30. The machine tool 12 includes the spindle 30, a spindle head 34 that rotatably drives the spindle 30 about a rotary axis (axis of rotation) parallel to the Z-direction, a column 36 that moves the spindle head 34 in the Z-direction (vertical direction), a table 38 on which the workpiece W is fixed and supported, and a table driving device 40 that causes the table 38 to move in the X-direction and the Y-direction. The X-direction, the Y-direction, and the Z-direction are mutually orthogonal with each other.

The tool 32 is retained by a tool holder 42, and is attached to the spindle 30 via the tool holder 42, which is capable of being attached to and detached from the spindle 30. The tool 32 is attached to the spindle 30 by inserting the tool holder 42 into a mounting hole (not shown) provided on the distal end of the spindle 30. The tool 32 is rotated together with the spindle 30. The machine tool 12 is configured as a machining center, which enables the tool 32 that is attached to the spindle 30 to be exchanged through an automatic tool exchanging device 44. The automatic tool exchanging device 44 includes a tool magazine 46 capable of accommodating (retaining) a plurality of tools 32, each of which is held by the tool holder 42. As examples of such tools 32, there may be cited a hale-machining tool, a drill, an end mill, a milling cutter, etc.

The table 38 is arranged below the spindle 30. On the upper surface of the table 38, lock grooves 48, which extend linearly in the X-direction, are formed at predetermined intervals along the Y-direction. The object to be machined W is fixed to the table 38 via a non-illustrated workpiece fixing jig. The workpiece fixing jig is constituted so as to be capable of being fixed to the upper surface of the table 38 using the lock grooves 48.

The table 38 is supported by the table driving device 40. The table driving device 40 includes a first slide member 50 that moves the table 38 in the X-direction, and a second slide member 52 that moves the table 38 in the Y-direction.

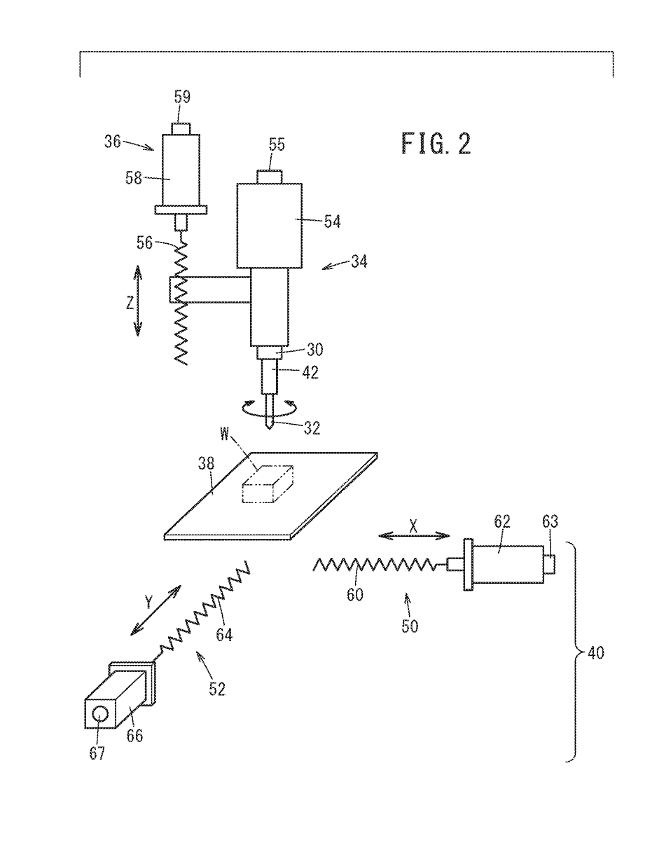

FIG. 2 is a view for explaining a drive system of the spindle 30 and the table 38. The spindle head 34 has a spindle rotation motor 54 for rotatably driving the spindle 30. In the case that a rotary tool 32 such as an end mill or the like is attached to the spindle 30, the spindle rotation motor 54 rotates the spindle 30. However, in the case that a stationary tool 32 such as a hale-machining tool is attached to the spindle 30, the spindle rotation motor 54 is used in order to control the phase (rotational position) of the spindle 30. An encoder 55 is provided on the spindle rotation motor 54 for detecting the rotational position of the spindle rotation motor 54.

The column 36 includes a spindle feed mechanism 56 as an elevating mechanism that moves the spindle head 34 along the Z-direction, and a spindle feed motor 58 that drives the spindle feed mechanism 56. An encoder 59 is provided on the spindle feed motor 58 for detecting the rotational position of the spindle feed motor 58.

The first slide member 50 of the table driving device 40 has an X-axis feed mechanism 60 that moves the table 38 in the X-direction, and an X-axis feed motor 62 that drives the X-axis feed mechanism 60. An encoder 63 is provided on the X-axis feed motor 62 for detecting the rotational position of the X-axis feed motor 62.

The second slide member 52 of the table driving device 40 has a Y-axis feed mechanism 64 that moves the first slide member 50 (table 38) in the Y-direction, and a Y-axis feed motor 66 that drives the Y-axis feed mechanism 64. An encoder 67 is provided on the Y-axis feed motor 66 for detecting the rotational position of the Y-axis feed motor 66.

By configuring the table driving device 40 in this manner, it is possible for the table 38 to be moved in the X-direction and the Y-direction. By moving the table 38 in the X-direction and the Y-direction, as well as moving the spindle 30 in the Z-direction, machining can be carried out in three dimensions with respect to the object to be machined W. Moreover, the spindle rotation motor 54, the spindle feed motor 58, the X-axis feed motor 62, and the Y-axis feed motor 66 are rotated (driven) in accordance with the control of the controller 18.

Returning to the description of FIG. 1, the articulated robot 16 includes three or more joints in which the axial directions of the axes of rotation thereof are parallel to each other. The articulated robot 16 of the present embodiment includes at least three joints (first to third joints) 70, 72, 74. The axial directions of the axes of rotation of the joints 70, 72, 74 lie parallel to the Y-direction. The articulated robot 16 is equipped with a base 80 that serves as a mounting platform, a first link 82 attached to the base 80 via the joint (first joint) 70, a second link 84 attached to the first link 82 via the joint (second joint) 72, and a third link 86 attached to the second link 84 via the joint (third joint) 74.

The first link 82 is capable of being rotated with respect to the base 80 by the first joint 70 about an axis (rotary axis) J1 that lies parallel to the Y-direction. The second link 84 is capable of being rotated with respect to the first link 82 by the second joint 72 about an axis (rotary axis) J2 that lies parallel to the axis J1. The third link 86 is capable of being rotated with respect to the second link 84 by the third joint 74 about an axis (rotary axis) J3 that lies parallel to the axis J2. The first joint 70 through the third joint 74 and the first link 82 through the third link 86 constitute an arm (articulated arm) 88. The axes J1 to J3 intersect with, and ideally are perpendicular to, the axial direction (Z-direction) of the spindle 30.

The first joint 70 is provided with a first joint motor 70a for rotating the first link 82 about the axis J1 with respect to the base 80. Similarly, the second joint 72 is provided with a second joint motor 72a for rotating the second link 84 about the axis J2 with respect to the first link 82, and the third joint 74 is provided with a third joint motor 74a for rotating the third link 86 about the axis J3 with respect to the second link 84.

Encoders 71, 73, 75 are provided on the first joint motor 70a through the third joint motor 74a for detecting the rotational positions of the first joint motor 70a through the third joint motor 74a. Moreover, the first joint motor 70a through the third joint motor 74a are rotated (driven) in accordance with the control of the controller 18.

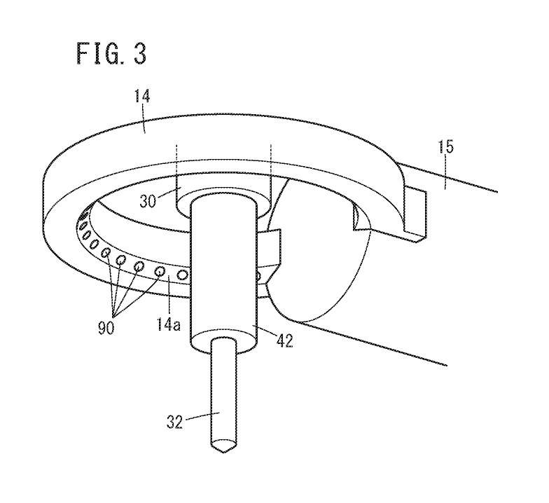

The robot hand 14 is attached to the distal end of the arm 88, and more specifically, to a distal end portion of the third link 86. As shown in FIG. 3, ejection holes 90 for ejecting the cutting fluid (machining fluid) toward the tool 32 or the tool holder 42 which is attached to the spindle 30 are formed in the robot hand 14. The robot hand 14 is formed so as to surround the tool 32 that is attached to the spindle 30, and the plurality of ejection holes 90 are formed in the robot hand 14. The robot hand 14 is positioned in such a manner that cutting fluid from each of the plurality of ejection holes 90 is ejected toward the tool 32 or the tool holder 42. Although not illustrated, the ejection holes 90 and a tank for storing the cutting fluid are connected by piping. The cutting fluid stored in the tank flows through the piping by way of a pump or the like, whereby the cutting fluid is ejected from the ejection holes 90.

The plurality of ejection holes 90 are formed in the robot hand 14 so that the machining liquid is ejected toward a predetermined spatial region. In addition, the robot hand 14 is positioned in such a manner that the predetermined spatial region overlaps a predetermined specified location (target ejection location) of the tool 32 or the tool holder 42. Consequently, the machining fluid from the plurality of ejection holes 90 is supplied to the predetermined specified location of the tool 32 or the tool holder 42. The specified location refers to a target ejection location where the cutting fluid should be applied (should be supplied) to the tool 32 or the tool holder 42.

According to the present embodiment, the robot hand 14 is formed in a ring-like shape, and the plurality of ejection holes 90 are formed on an interior side of the robot hand 14 that is formed in a ring-like shape, or in other words, on a side in facing relation to the tool 32 or the tool holder 42 of the robot hand 14. Further, the plurality of ejection holes 90 are formed along the interior side of the ring-shaped robot hand 14, and in surrounding relation to the tool 32 or the tool holder 42. The plurality of ejection holes 90 eject the cutting fluid toward a predetermined spatial region set inside the robot hand 14 that is formed in a ring-like shape. The ring-like shape includes not only an O-shape (annular shape), but may also include a C-shape, a U-shape, or the like, in which a portion of the ring-like shape is cut out. Stated otherwise, the ring-like shape includes shapes in which a portion thereof is curved in a circular shape.

Moreover, the predetermined spatial region may be a region that is smaller than the specified location (of the tool 32 or the tool holder 42) on a plane (XY plane) orthogonal to the axial direction (a direction parallel to the Z-direction) of the spindle 30. Consequently, since the specific location is larger than the predetermined spatial region, all of the cutting fluid that is ejected from the plurality of ejection holes 90 is supplied to the specified location of the tool 32 or the tool holder 42. In this case, the diameter of the predetermined spatial region may be smaller than the diameter of the specified location (of the tool 32 or the tool holder 42) on the plane (XY plane) orthogonal to the axial direction (a direction parallel to the Z-direction) of the spindle 30. The robot hand 14 is attached to the distal end portion of the third link 86 via a proximal end portion 15 that is provided on the robot hand 14 (see FIGS. 1 and 3).

The center position on the XY plane of the predetermined spatial region that serves as the target ejection region is taken to be a predetermined position. This predetermined position may be a substantially central position of the robot hand 14 that is formed in a ring-like shape. By positioning the predetermined position (for example, the substantially central position of the robot hand 14) on the axial direction of the spindle 30 (tool 32), the predetermined spatial region that serves as the target ejection region overlaps with the predetermined specified location of the tool 32 or the tool holder 42.

A surface 14a on which the plurality of ejection holes 90 are formed may be inclined so that the cutting fluid from the ejection holes 90 is ejected downwardly toward the tool 32 or the tool holder 42. In accordance with this feature, the predetermined spatial region is located below the robot hand 14.

The controller 18 includes a processor such as a CPU or the like, and a storage medium in which a basic program is stored. By executing the basic program, the processor functions as the controller 18 of the present embodiment. Further, although not illustrated, the controller 18 has an input unit in order for an operator to input information and commands, and a display unit for displaying information required by the operator, etc.

The controller 18 analyzes the machining program stored in the storage medium, and based on the analysis result thereof, the spindle rotation motor 54, the spindle feed motor 58, the X-axis feed motor 62, and the Y-axis feed motor 66 are feedback controlled. Moreover, the rotational positions detected by the encoders 55, 59, 63, 67 are used in the feedback control of the spindle rotation motor 54, the spindle feed motor 58, the X-axis feed motor 62, and the Y-axis feed motor 66.

Further, when the spindle feed motor 58 is driven and axially feeds the spindle 30 in the Z-direction, the controller 18 feedback controls the first joint motor 70a through the third joint motor 74a in synchronism with the feeding operation of the spindle 30, in such a manner that the robot hand 14 moves along the axial direction of the spindle 30. Stated otherwise, the controller 18 moves the robot hand 14 along the Z-direction in synchronism with the feeding operation of the spindle 30, so that the relative positional relationship between the spindle 30 and the robot hand 14 is maintained. Moreover, the rotational positions detected by the encoders 71, 73, 75 are used for implementing the feedback control of the first joint motor 70a through the third joint motor 74a.

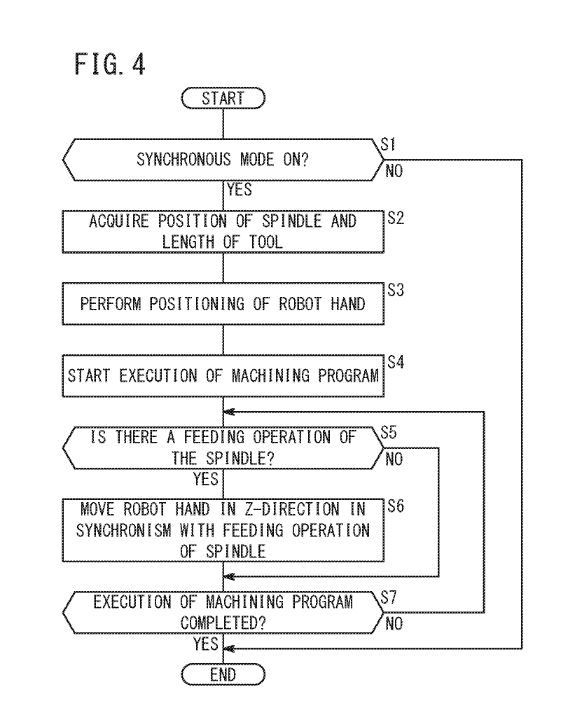

Next, operations of the controller 18 will be described with reference to the flowchart shown in FIG. 4. In step S1, the controller 18 determines whether or not a synchronous mode has been turned on through operation of the input unit made by the operator. If it is determined in step S1 that the synchronous mode has not been turned on, the current operation is terminated.

If it is determined in step S1 that the synchronous mode has been turned on, the process proceeds to step S2, whereupon the controller 18 acquires the position of the spindle 30 in the Z-direction, and the length (the length in the Z-direction) of the tool 32 that is attached to the spindle 30.

The controller 18 may acquire the position of the spindle 30 in the Z-direction on the basis of the rotational position detected by the encoder 59, or may acquire the position of the spindle 30 in the Z-direction from a non-illustrated position sensor, which detects the position of the spindle 30 in the Z-direction. The controller 18 may acquire the length of the tool 32 from information indicative of the type of tool 32 (the tool 32 attached to the spindle 30) which was input by an operation of the input unit made by the operator. Further, the controller 18 may acquire the length of the tool 32 (the tool 32 attached to the spindle 30) which was input directly by an operation of the input unit made by the operator.

Next, in step S3, the controller 18 positions the robot hand 14 based on the position of the spindle 30 and the length of the tool 32 that were acquired in step S2. More specifically, from the acquired position of the spindle 30 and the length of the tool 32, the controller 18 specifies a specified location of the tool 32 or the tool holder 42 to be the target ejection location. In addition, the controller 18 controls the first joint 70 through the third joint 74, so that the predetermined spatial region, which is the target ejection region for the cutting fluid by the plurality of ejection holes 90 that are formed in the robot hand 14, overlaps with the specified location of the tool 32 or the tool holder 42. At this time, preferably, the predetermined position of the predetermined spatial region (the central position of the predetermined spatial region on the XY plane) is positioned on the axial direction of the spindle 30.

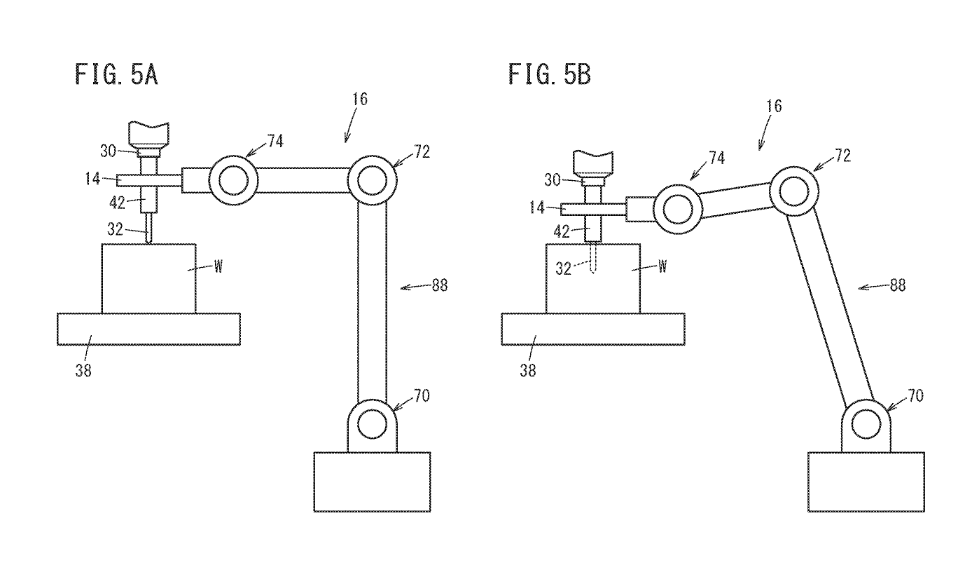

Consequently, the plurality of ejection holes 90 are capable of ejecting the cutting fluid toward the specified location of the tool 32 or the tool holder 42. FIG. 5A is a diagram showing an example of a state in which the robot hand 14 is positioned in step S3. The feature of controlling the first joint 70 through the third joint 74 more specifically implies a feedback control of the first joint motor 70a through the third joint motor 74a.

Next, in step S4, the controller 18 initiates execution of the machining program. Stated otherwise, the controller 18 analyzes the machining program, and based on the analysis result thereof, controls driving of the table 38 and the spindle 30. As a result, machining with respect to the workpiece W is initiated. Upon execution of the machining program, the table 38 moves in the X-direction and the Y-direction, and the spindle 30 (tool 32) moves in the Z-direction in accordance with the machining program. At this time, by controlling the pump, the controller 18 begins to eject the cutting fluid from the ejection holes 90. Consequently, the cutting fluid is supplied to the specified location of the tool 32 or the tool holder 42.

Next, in step S5, the controller 18 determines whether or not an operation to be performed henceforth on the basis of the machining program is a feeding operation for the spindle 30. If it is determined in step S5 that the operation to be performed from now on is a feeding operation for the spindle 30, the controller 18 controls the first joint 70 through the third joint 74 (step S6), in such a manner that the robot hand 14 moves along the axial direction (Z-direction) of the spindle 30 in synchronism with the feeding operation of the spindle 30, whereupon the process proceeds to step S7.

Based on the end point position and the speed, etc., of the feeding operation of the spindle 30 as determined on the basis of the machining program, the controller 18 controls the first joint 70 through the third joint 74 so that the robot hand 14 moves in the Z-direction in synchronism with the feeding operation of the spindle 30. FIG. 5B is a view showing one example of a state when the robot hand 14 is moved along the Z-direction in synchronism with a feeding operation of the spindle 30 in step S6. As can be understood from FIGS. 5A and 5B, even in the case that the spindle 30 is axially fed in the Z-direction, the relative positional relationship between the spindle 30 (the tool 32, the tool holder 42) and the robot hand 14 (the ejection holes 90) does not change.

Further, in the case that the robot hand 14 is moved along the Z-direction in synchronism with the feeding operation of the spindle 30, the controller 18 moves the robot hand 14 along the Z-direction while maintaining a state in which the predetermined spatial region, which is the target ejection region for the cutting fluid by the ejection holes 90, overlaps with the specified location of the tool 32 or the tool holder 42. Accordingly, even if the spindle 30 is moved in the Z-direction, the plurality of ejection holes 90 can continue to supply the cutting fluid to the specified location of the tool 32 or the tool holder 42. At this time, the robot hand 14 may be moved in the Z-direction in synchronism with the feeding operation of the spindle 30, so as to maintain a state in which the predetermined position of the predetermined spatial region (the central position of the predetermined spatial region on the XY plane) is positioned on the axial direction of the spindle 30.

On the other hand, if it is determined in step S5 that the operation to be performed from now on is not the feeding operation of the spindle 30, the process proceeds directly to step S7.

Upon proceeding to step S7, the controller 18 determines whether or not execution of the machining program has ended. The controller 18 determines that execution of the machining program has ended when all of the codes described in the machining program are executed. If it is determined in step S7 that execution of the machining program has not ended, the process returns to step S5 and the aforementioned operations are repeated. On the other hand, if it is determined in step S7 that execution of the machining program has ended, the current operation is terminated. Accompanying termination of the current operation, the controller 18 controls the pump in order to terminate ejection of the cutting fluid from the ejection holes 90.

As described above, in the fluid ejection device 20 according to the present embodiment, the cutting fluid is ejected toward the tool holder 42 or the tool 32 from the periphery of the spindle 30 of the machine tool 12 to which the tool 32 is attached through the tool holder 42. The fluid ejection device 20 is equipped with the robot hand 14, which is attached to a distal end of the arm 88 of the articulated robot 16, and having the ejection holes 90 therein for ejecting the cutting fluid toward the tool holder 42 or the tool 32, and the controller 18 adapted to control the joints 70, 72, 74 of the articulated robot 16, in such a manner that the robot hand 14 moves along an axial direction (Z-direction) of the spindle 30 in synchronism with the feeding operation by which the spindle 30 is moved along the axial direction (Z-direction) of the spindle 30.

Consequently, since the robot hand 14 is moved along the movement direction (Z-direction) of the spindle 30 in synchronism with the feeding operation of the spindle 30, the relative positional relationship can be maintained between the robot hand 14, and the tool 32 and the tool holder 42 that are attached to the spindle 30. Accordingly, even in the case that the spindle 30 is moved, the cutting fluid can be supplied to the tool 32 or the tool holder 42, and it is possible to prevent a decrease in the lubrication effect, the cooling effect, and the chip removal effect of the cutting fluid. As a result, the cutting ability can be utilized to the greatest effect, and machining that implements high speed cutting or heavy cutting is performed in a stable manner.

Further, since the cutting ability can be utilized to the greatest effect, the machining time can be shortened, and the number of machine tools can be reduced. Since the cutting fluid is ejected using the robot hand 14 that is attached to the arm 88 of the articulated robot 16, even if the length of the tool 32 is changed by replacement of the tool 32, such a change can be coped with easily.

The robot hand 14 is formed so as to surround the tool 32 that is attached to the spindle 30, and the plurality of ejection holes 90 are formed in the robot hand 14. In this manner, since the ejection holes 90 are provided in plurality, the cutting fluid can be ejected from different directions toward the tool 32 or the tool holder 42. Consequently, it is possible to prevent a decrease in the lubrication effect, the cooling effect, and the chip removal effect of the cutting fluid.

The plurality of ejection holes 90 are formed in the robot hand 14 so that the machining liquid is ejected toward a predetermined spatial region. The controller 18 controls the joints 70, 72, 74 of the articulated robot 16 in such a manner that the robot hand 14 moves along the axial direction of the spindle 30 while maintaining the state in which the predetermined spatial region overlaps with the predetermined specified location of the tool holder 42 or the tool 32. In accordance with this feature, even in the case that the robot hand 14 is moved along the movement direction (Z-direction) of the spindle 30 in synchronism with the feeding operation of the spindle 30, it is possible to supply the cutting fluid to the specified location, which is the target ejection location, from the plurality of ejection holes 90. Consequently, it is possible to prevent a decrease in the lubrication effect, the cooling effect, and the chip removal effect of the cutting fluid.

The predetermined spatial region is a region that is smaller than the specified location on a plane (XY plane) orthogonal to the axial direction of the spindle 30. Owing to this feature, it is possible to reliably supply the cutting fluid toward the specified location, which is the target ejection location.

The robot hand 14 is formed in a ring-like shape, and the predetermined spatial region is set on the inner side of the robot hand 14. In accordance with this feature, since the cutting fluid is supplied from the periphery of the specified location, it is possible to prevent a decrease in the lubrication effect, the cooling effect, and the chip removal effect of the cutting fluid.

According to the above-described embodiment, although the spindle 30 is configured to move only in the axial direction (Z-direction) of the spindle 30, the spindle 30 may also be moved in the X-direction and the Y-direction. In this case, the articulated robot 16 may be configured so that the robot hand 14 is capable of following with and tracking the movement of the spindle 30 on the XY plane. For example, the articulated robot 16 may be configured in such a manner that the arm 88 is capable of pivoting on the XY plane with respect to the base 80 (the arm 88 can rotate about a rotary axis lying parallel to the Z-direction). More specifically, the base 80 includes a first member 80a, and a second member 80b provided on a side in the +Z direction of the first member 80a (see FIG. 1). Additionally, the articulated robot 16 may be configured such that the second member 80b, to which the arm 88 (the first link 82) is connected through the first joint 70, rotates with respect to the first member 80a about an axis J4 parallel to the Z-axis direction. Further, the articulated robot 16 may be configured so that the arm 88 is capable of moving in the X-direction and the Y-direction with respect to the base 80.

Further, although the machine tool 12 and the articulated robot 16 are controlled by a single controller 18, a total of two controllers may be provided, including a controller for the machine tool and a controller for the articulated robot. In this case, since it is necessary for the robot hand 14 to be moved in the Z-direction in synchronism with movement of the spindle 30 in the Z-direction, the controller for the machine tool and the controller for the articulated robot are made capable of communicating with each other. In the case that the spindle 30 is moved in the Z-direction, the controller for the machine tool transmits to the controller for the articulated robot information (feeding operation information) of the end point position and movement speed, etc., of the feeding operation, and the robot hand 14 is moved by the controller for the articulated robot on the basis of the feeding operation information.

Further, although the articulated robot 16 is configured such that the axes of rotation J1 to J3 of the joints 70, 72, 74 and the axial direction (Z-direction) of the spindle 30 intersect (ideally, orthogonally) with each other, the axes of rotation J1 to J3 of the joints 70, 72, 74 may lie parallel to the axial direction (Z-direction) of the spindle 30. In essence, it is sufficient if the articulated robot 16 is capable of moving the robot hand 14 in the feeding direction of the spindle 30 in synchronism with the feeding direction (Z-direction) of the spindle 30.

Although a certain preferred embodiment of the present invention has been shown and described in detail, it should be understood that various changes and modifications may be made to the embodiment without departing from the scope of the invention as set forth in the appended claims.

What is claimed is:

1. A fluid ejection device configured to eject a cutting fluid toward a tool holder or a tool from a periphery of a spindle of a machine tool to which the tool is attached through the tool holder, comprising:
a robot hand which is attached to a distal end of an arm of an articulated robot, and including an ejection hole therein in order to eject the cutting fluid toward the tool holder or the tool; and
a controller configured to control joints of the articulated robot, in a manner that the robot hand moves along an axial direction of the spindle in synchronism with a feeding operation by which the spindle is moved along the axial direction of the spindle.

2. The fluid ejection device according to claim 1, wherein the controller controls the joints of the articulated robot in a manner that the robot hand moves along the axial direction of the spindle while maintaining a state in which the cutting fluid ejected from the ejection hole is supplied to a predetermined specified location of the tool holder or the tool.

3. The fluid ejection device according to claim 1, wherein:
the robot hand is formed so as to surround the tool that is attached to the spindle; and
a plurality of the ejection holes are formed in the robot hand.

4. The fluid ejection device according to claim 3, wherein:
the plurality of ejection holes are formed in the robot hand in a manner that the cutting fluid is ejected toward a predetermined spatial region; and
the controller controls the joints of the articulated robot in a manner that the robot hand moves along the axial direction of the spindle while maintaining a state in which the predetermined spatial region overlaps with the predetermined specified location of the tool holder or the tool.

5. The fluid ejection device according to claim 4, wherein the predetermined spatial region is a region that is smaller than the specified location on a plane perpendicular to the axial direction of the spindle.

6. The fluid ejection device according to claim 4, wherein:
the robot hand is formed in a ring-like shape, and
the predetermined spatial region is set on an inner side of the robot hand.
